(19) United States
(12) Patent Application Publication
(10) Pub. No.: US 2026/0368310 A1
(43) Pub. Date: Nov. 19, 2026

(54) PREDICTING TIME TO RESOLUTION OF A SECURITY INCIDENT

(71) Applicant: International Business Machines Corporation, Armonk, NY (US)

(72) Inventors: Vikram Subhash KHOPADE, Pune (IN); Ashish Mohan KOTHEKAR, Pune (IN); Boudhayan CHAKRABARTY, Pune (IN); Yogesh S. TALEKAR, Pune (IN); Sanjay B. PANCHAL, Mumbai (IN)

(21) Appl. No.: 19/207,969

(22) Filed: May 14, 2025

(51) Int. Cl. G06F 21/55

(52) U.S. Cl. CPC G06F 21/552; G06F 2221/034

(57) ABSTRACT

In some implementations, a computer system may receive a security incident from a security system, and may determine whether the security incident is an old security incident or a new security incident. The computer system may selectively process the security incident, with a machine learning model and based on determining that the security incident is an old security incident, to predict an estimated time for resolution of the old security incident, or perform one or more actions based on determining that the security incident is a new security incident and to predict an estimated time for resolution of the new security incident.

### BACKGROUND

Cybersecurity involves protecting various technological systems and networks. Organizations utilize a myriad of tools and technologies to manage and respond to various security incidents.

### SUMMARY

Some implementations described herein relate to a method. The method may include receiving a security incident from a security system, and determining whether the security incident is an old security incident or a new security incident. The method may include selectively processing the security incident, with a machine learning model and based on determining that the security incident is an old security incident, to predict an estimated time for resolution of the old security incident, or performing one or more actions based on determining that the security incident is a new security incident and to predict an estimated time for resolution of the new security incident.

Some implementations described herein relate to a computer system. The computer system may include a processor set, one or more computer-readable storage media, and program instructions stored on the one or more computer-readable storage media to cause the processor set to perform operations. The operations may include receiving a security incident from a security system, and determining whether the security incident is an old security incident or a new security incident. The operations may include selectively processing the security incident, with a machine learning model and based on determining that the security incident is an old security incident, to predict an estimated time for resolution of the old security incident, or performing one or more actions based on determining that the security incident is a new security incident and to predict an estimated time for resolution of the new security incident. The operations may include outputting one of the estimated time for resolution of the old security incident or the estimated time for resolution of the new security incident.

Some implementations described herein relate to a computer program product. The computer program product may include one or more computer-readable storage media and program instructions stored on the one or more computer-readable storage media to perform operations. The operations may include receiving a security incident from a security system, and determining whether the security incident is an old security incident or a new security incident. The operations may include selectively processing the security incident, with a machine learning model and based on determining that the security incident is an old security incident, to predict an estimated time for resolution of the old security incident, or performing one or more actions based on determining that the security incident is a new security incident and to predict an estimated time for resolution of the new security incident. The operations may include providing for display one of the estimated time for resolution of the old security incident or the estimated time for resolution of the new security incident.

### BRIEF DESCRIPTION OF THE DRAWINGS

FIG. 1 is a diagram of an example computing environment for predicting time to resolution of security incident, as described herein.

FIGS. 2A-2I are diagrams of an example associated with predicting time to resolution of security incident.

FIG. 3 is a flowchart of an example process associated with predicting time to resolution of security incident.

### DETAILED DESCRIPTION

The following detailed description of example implementations refers to the accompanying drawings. The same reference numbers in different drawings may identify the same or similar elements.

Organizations typically employ security systems to monitor their information technology (IT) infrastructure for potential security threats. These security systems generate alerts or offenses when suspicious activity (e.g., a security incident) is detected, which must then be investigated and resolved by security analysts. However, the time it takes to resolve a security incident can vary significantly, depending on the complexity of the incident, the availability of resources, and the levels of decision-making involved. This can make it challenging for organizations to predict when a security incident will be resolved, making it difficult for the organizations to make informed business decisions. The lack of knowledge regarding security incident resolution times may cause organizations to be unable to prioritize responses to security incidents, allocate resources effectively, and minimize downtime. Furthermore, the lack of visibility into the resolution process can lead to frustration and uncertainty among stakeholders. Thus, current methods for handling security incidents consume computing resources (e.g., processing resources, memory resources, communication resources, and/or the like), networking resources, and/or the like associated with failing to predict resolution times for security incidents, failing to prioritize security incidents based on failing to predict the resolution times, allocating insufficient resources to security incidents based on failing to predict the resolution times, handling downtime based on failing to predict the resolution times, and/or the like.

Some implementations described herein provide a computer system for predicting time to resolution of a security incident. For example, the computer system may receive a security incident from a security system, and may determine whether the security incident is an old security incident or a new security incident. The computer system may selectively process the security incident, with a machine learning model and based on determining that the security incident is an old security incident, to predict an estimated time for resolution of the old security incident, or perform one or more actions based on determining that the security incident is a new security incident and to predict an estimated time for resolution of the new security incident. The computer system may output one of the estimated time for resolution of the old security incident or the estimated time for resolution of the new security incident.

In this way, the computer system predicts time to resolution of security incidents. For example, the computer system may optimize resource allocation and reduce computational overhead by predicting the time to resolution of a security incident. The computer system may streamline the resolution process by reducing the need for manual intervention, minimizing the number of redundant tasks, and optimizing the execution of rule responses. The computer system may also reduce network latency and improve system availability by quickly resolving security incidents and minimizing downtime. Thus, the computer system conserves computing resources, networking resources, and/or the like that would otherwise have been consumed by failing to predict resolution times for security incidents, failing to prioritize security incidents based on failing to predict the resolution times, allocating insufficient resources to security incidents based on failing to predict the resolution times, handling downtime based on failing to predict the resolution times, and/or the like.

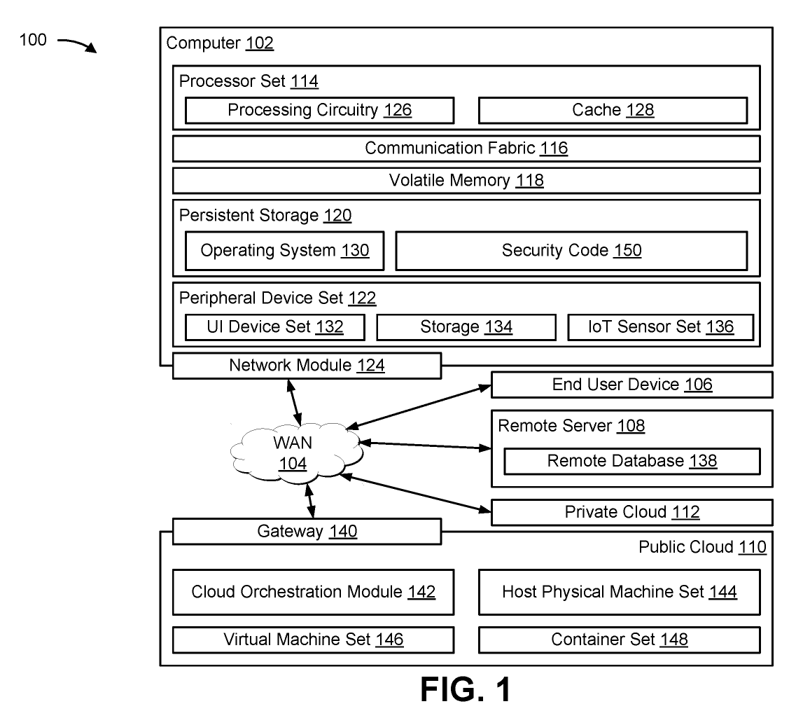

FIG. 1 is a diagram of an example computing environment 100 for predicting time to resolution of security incident, as described herein.

Computing environment 100 contains an example of an environment for the execution of at least some of the computer code involved in performing the inventive methods, such as security code 150 (e.g., code for predicting time to resolution of security incident). In addition to security code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and security code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in security code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

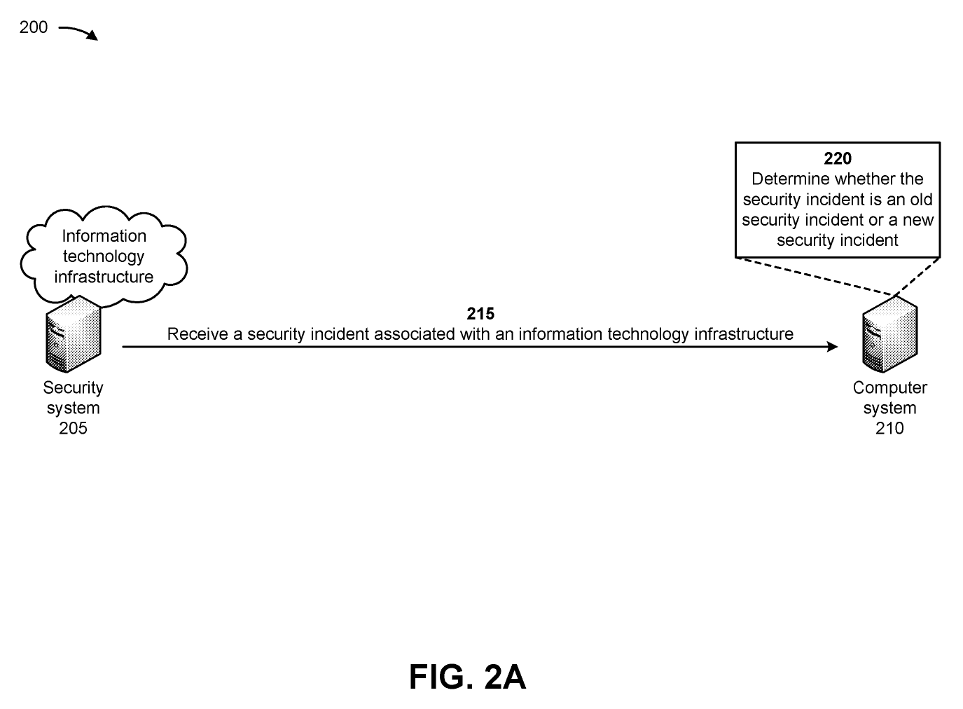

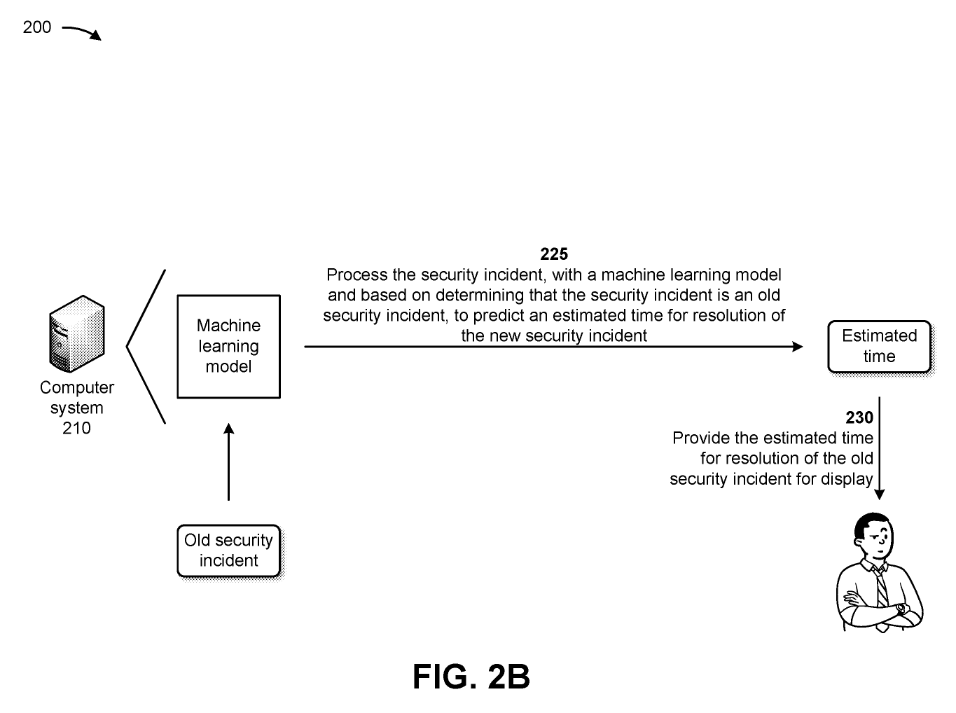

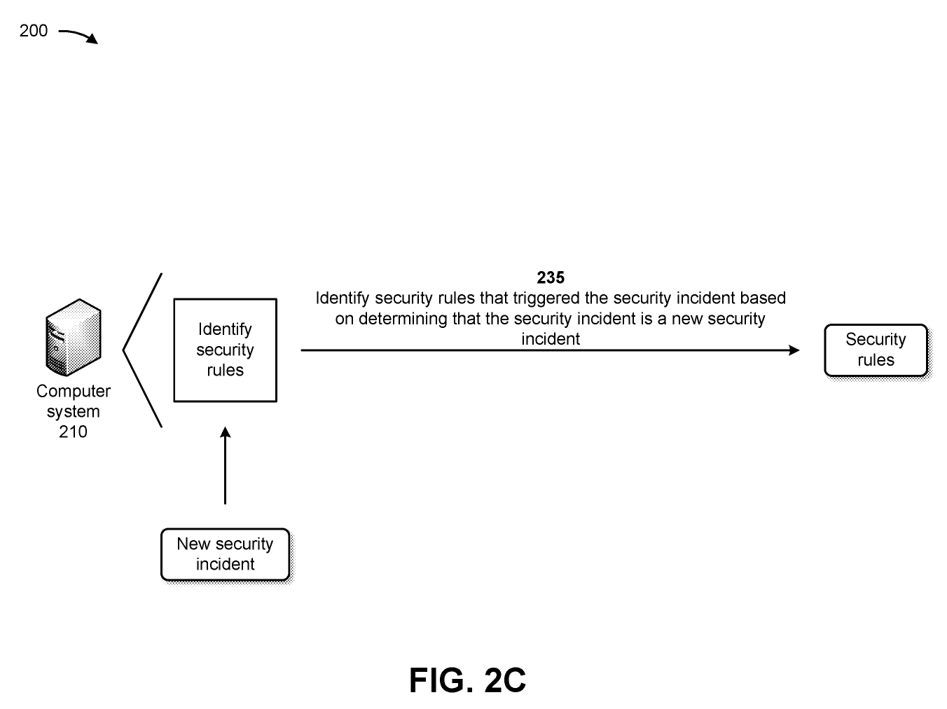

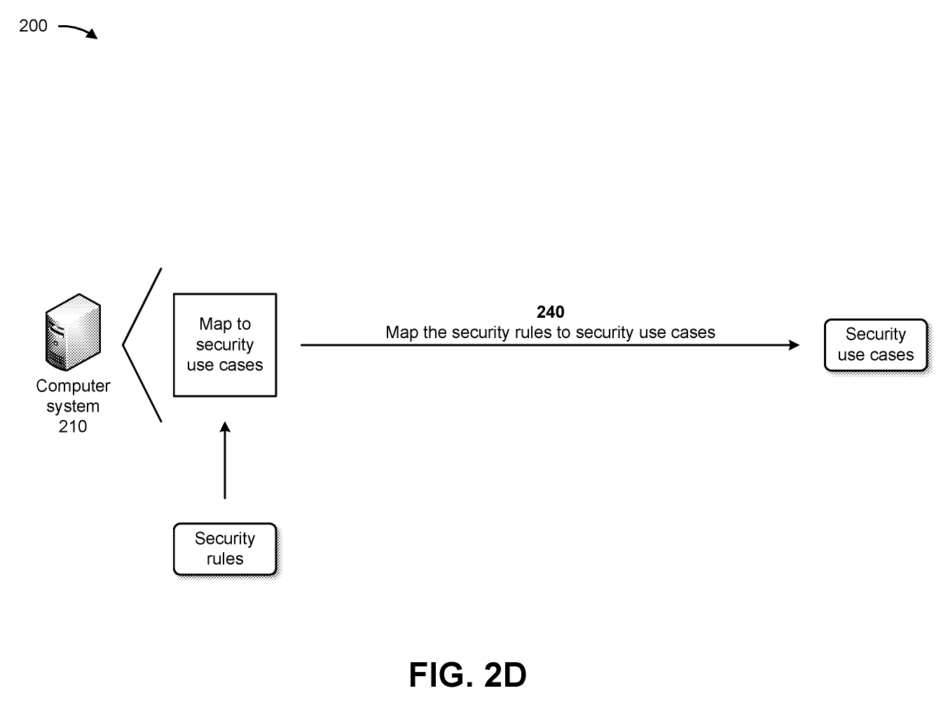

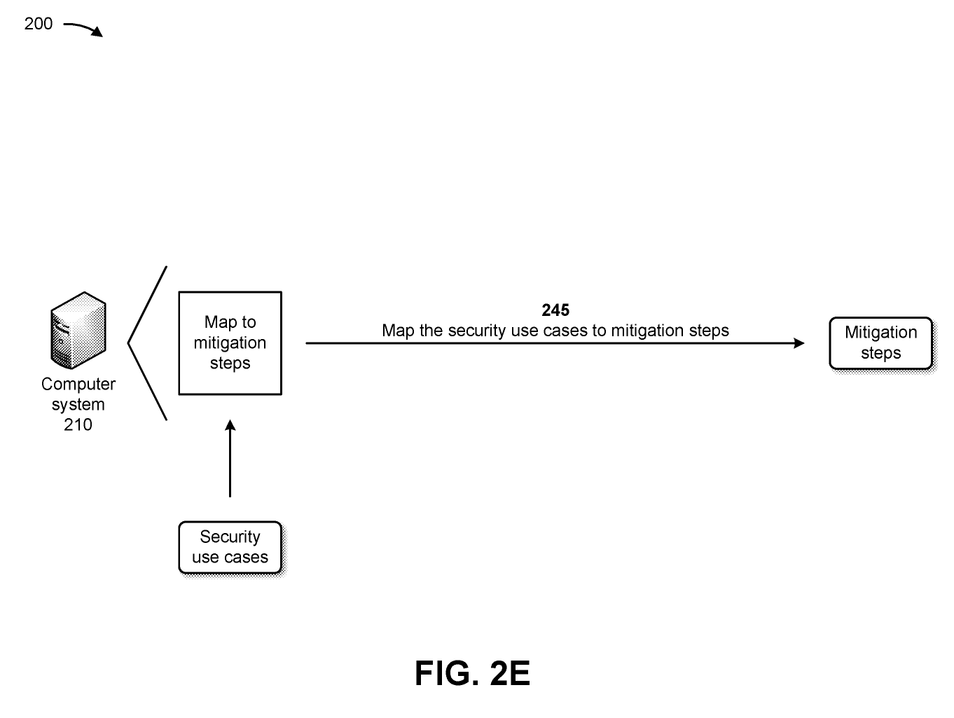

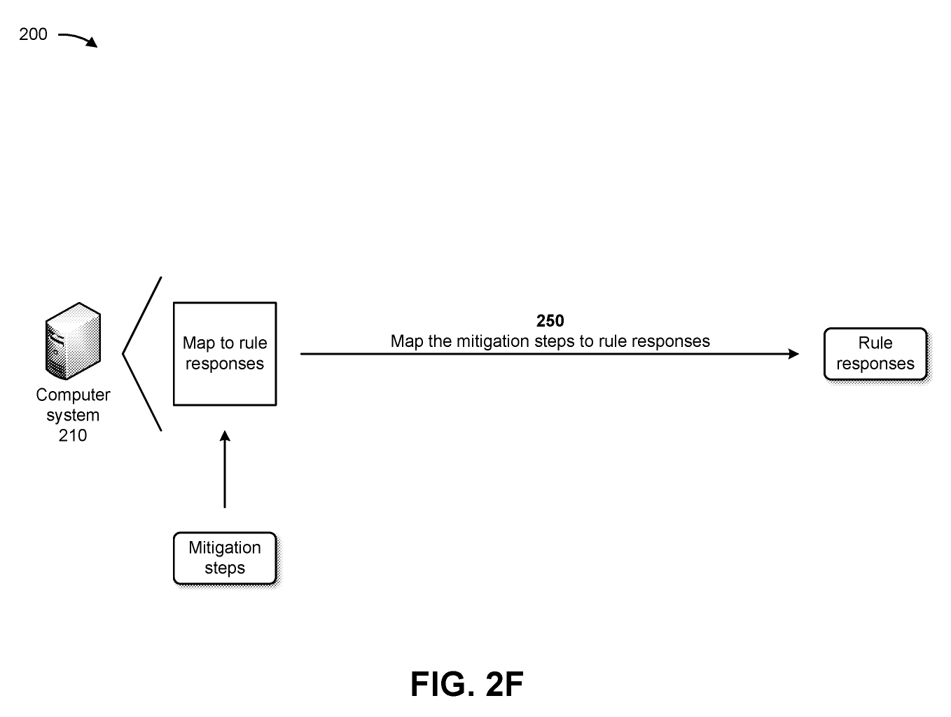

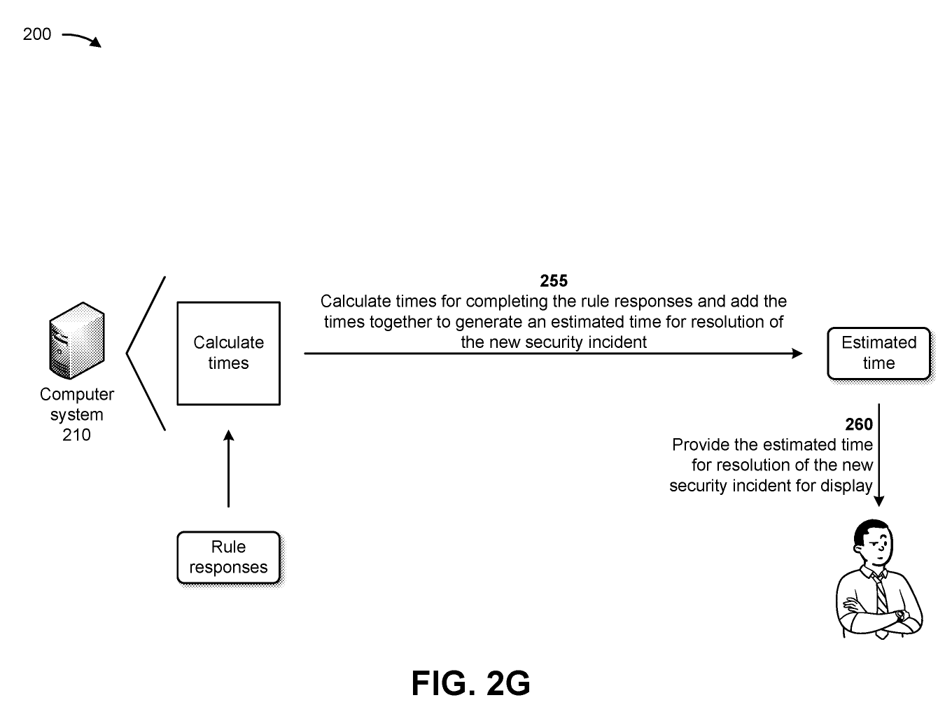

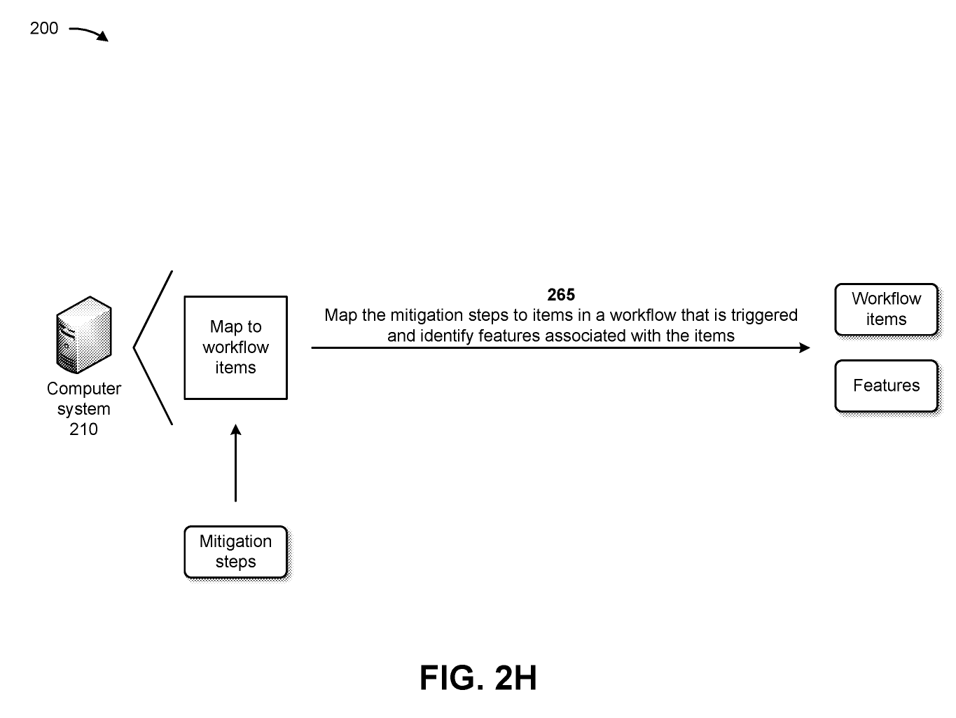

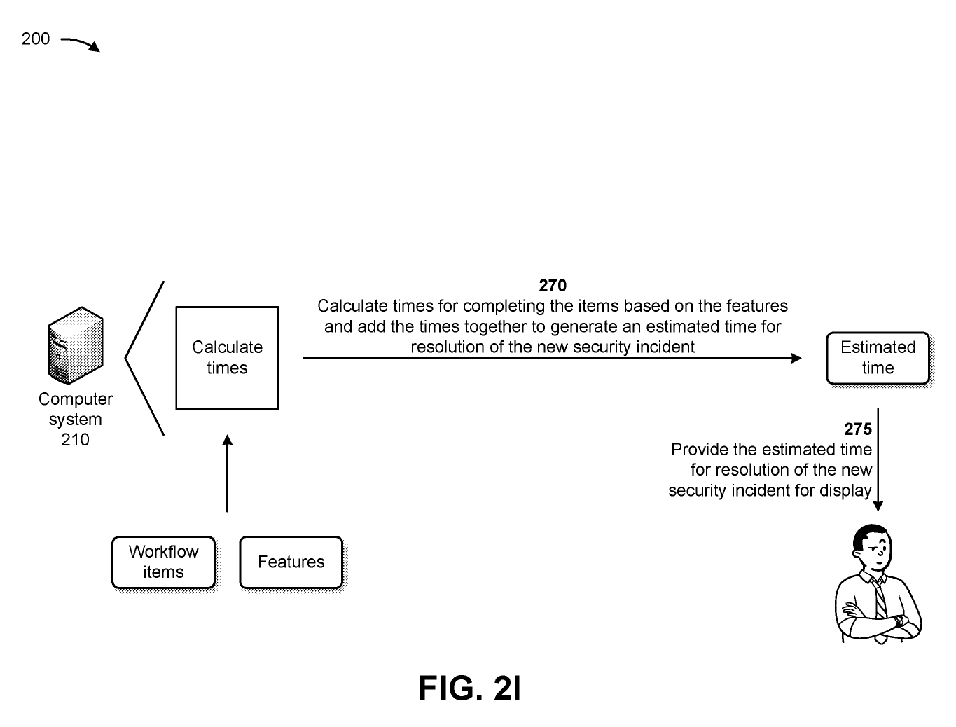

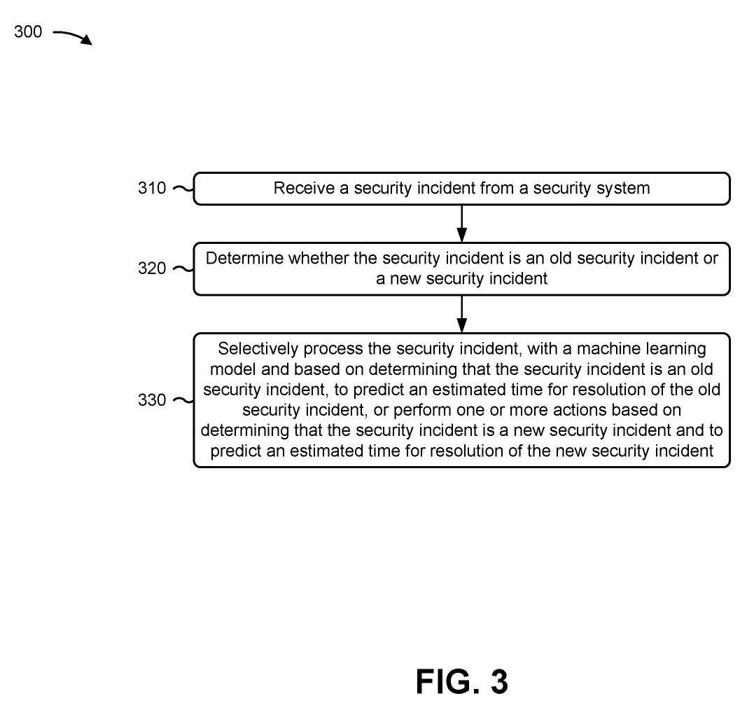

The code included in the security code 150 typically includes at least some of the computer code involved in performing one or more operations described herein, such as the operations of example 200 in FIGS. 2A-2I and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2I are diagrams of an example 200 associated with predicting time to resolution of security incident. As shown in FIGS. 2A-2I, the example 200 includes a security system 205 associated with an IT infrastructure and a computer system 210. The IT infrastructure may include an enterprise system, a company LAN, a cloud-based infrastructure, and/or the like. Each of the security system 205 and the computer system 210 may correspond to the computer 102, the remote server 108, a system provided by the public cloud 110, and/or a system provided by the private cloud 112. Further details of the security system 205, the IT infrastructure, and the computer system 210 are provided elsewhere herein.

As shown in FIG. 2A, and by reference number 215, the computer system 210 may receive a security incident associated with the IT infrastructure. For example, the security system 205 may generate a security incident, such as a phishing attack, a ransomware attack, unauthorized access (e.g., a former employee, contractor, or external hacker gains unauthorized access to the IT infrastructure), a data breach, denial of service (DoS) or distributed denial of device (DDoS) attacks, a malware outbreak, a physical security breach, a social engineering attack, unauthorized changes to system configurations, lost or stolen devices, an account takeover, cryptjacking, a Trojan horse attack, and/or the like. The security system 205 may provide the security incident to the computer system 210, and the computer system 210 may receive the security incident from the security system 205. In some implementations, the computer system 210 may receive the security incident in real-time (e.g., when detected by the security system 205) from the security system 205.

The security incident may be an old security incident, for which the computer system 210 has previously predicted an estimated time for resolution. Alternatively, the security incident may be a new security incident, for which the computer system 210 has not previously predicted an estimated time for resolution. In some implementations, the security incident may be associated with one or more security rules that triggered the security incident. For example, the computer system 210 may store and/or have access to security rules, such as malware signatures, anomalous network traffic patterns, unauthorized access attempts, and/or the like, and may store and/or have access to data indicating which security rules triggered the security incident.

As further shown in FIG. 2A, and by reference number 220, the computer system 210 may determine whether the security incident is an old security incident or a new security incident. For example, the computer system 210 may store and/or have access to data regarding previous security incidents, such as resolved security incidents, unresolved security incidents, and/or the like, and may compare data regarding the received security incident to the data regarding the previous security incidents to determine whether the security incident is an old security incident or a new security incident. The computer system 210 may utilize various methods to determine whether the security incident is an old security incident or a new security incident.

In some implementations, the computer system 210 may create a unique hash value for each security incident based on characteristics of the security incident, such as the type of attack, targeted systems, and exploited vulnerabilities. The computer system 210 may then compare the hash value of the current security incident with the hash values of previously recorded security incidents. If a match is found, the computer system 210 may consider the security incident an old security incident.

Alternatively, or additionally, the computer system 210 may utilize predefined security incident signatures to identify known security incidents. These signatures may be based on various factors, such as network traffic patterns, system logs, and vulnerability exploitations. For example, the computer system 210 may extract relevant data from the security incident, such as network traffic logs and system logs, and may compare the extracted data with the pre-defined security incident signatures. If a match is found, the computer system 210 may consider the current security incident as an old security incident.

Alternatively, or additionally, the computer system 210 may utilize a clustering model to group similar security incidents together based on characteristics. For example, the computer system 210 may extract relevant features from the security incident, such as attack type, targeted systems, and exploited vulnerabilities. The computer system 210 may apply a clustering model (e.g., a k-means model or a hierarchical clustering model) to group similar security incidents together. If the current security incident is assigned to a cluster with existing security incidents, the computer system 210 may consider the security incident as an old security incident.

Alternatively, or additionally, the computer system 210 may utilize a machine learning model to calculate a similarity between the current security incident and previously recorded security incidents. For example, the computer system 210 may extract relevant features from the security incident, such as attack type, targeted systems, and exploited vulnerabilities, and may utilize a similarity metric (e.g., a cosine similarity or a Euclidean distance) to calculate a similarity between the current security incident and the previously recorded security incidents. If the similarity score satisfies (e.g., exceeds) a predefined threshold, the computer system 210 may consider the current security incident as an old security incident.

Alternatively, or additionally, the computer system 210 may utilize a knowledge graph to store and query security incident-related information, including relationships between security incidents, entities, and vulnerabilities. For example, the computer system 210 may extract relevant entities and relationships from the security incident, such as an attacker network address, a targeted system, and an exploited vulnerability. The computer system 210 may query the knowledge graph to identify if similar security incidents have occurred in the past. If a match is found, the computer system 210 may consider the current security incident as an old security incident.

As shown in FIG. 2B, and by reference number 225, the computer system 210 may process the security incident, with a machine learning model and based on determining that the security incident is an old security incident, to predict an estimated time for resolution of the old security incident. For example, if the computer system 210 determines that the security incident is an old security incident, the computer system 210 may process the security incident, with the machine learning model, to predict an estimated time for resolution of the old security incident (e.g., the received security incident). In some implementations, the computer system 210 may retrieve relevant data related to old security incidents, such as type (e.g., malware, phishing, and unauthorized access), severity (e.g., low, medium, or high), scope (e.g., number of affected systems, users, or data), description (e.g., a brief summary), historical data on the old security incidents (e.g., resolution times, tactics, techniques, and procedures used by attackers), and a current state of the IT infrastructure (e.g., network traffic, system logs, and system performance metrics). The computer system 210 may preprocess the relevant data related to old security incidents to prepare the data for input into the machine learning model. The preprocessing may include normalization (e.g., scaling numeric features to a common range), feature extraction (e.g., extracting relevant features from text descriptions), handling missing values (e.g., imputing or removing missing data), and/or the like.

The computer system 210 may select a suitable machine learning model for predicting the estimated time for resolution of the old security incident. The machine learning model may be selected chosen based on factors such as model accuracy, model interpretability, computational resources available, and/or the like. The selected machine learning model may include a linear regression model that predicts the estimated time for resolution based on a linear combination of incident characteristics, a decision tree model that predicts the estimated time for resolution based on a hierarchical analysis of incident characteristics, a random forest model that combines multiple decision trees to predict the estimated time for resolution, a neural network model that predicts the estimated time for resolution based on complex patterns in incident data, a support vector machine model that predicts the estimated time for resolution based on finding the optimal hyperplane that separates incident data into different resolution time categories, and/or the like.

The computer system 210 may train the selected machine learning model on a dataset of historical security incidents and corresponding resolution times. The training process may include providing the preprocessed data to the machine learning model, adjusting model hyperparameters to optimize performance, and evaluating model performance using metrics such as mean squared error or mean absolute error. Once the machine learning model is trained, the computer system 210 may input the preprocessed data for the current security incident into the machine learning model to predict the estimated time for resolution. The prediction may be based on the machine learning model’s analysis of the security incident’s characteristics, such as incident type and severity, incident scope and description, historical data on similar security incidents, and a current system state. The computer system 210 may adjust the predicted estimated time for resolution for any factors not considered by the machine learning model, such as availability of personnel and resources to address the security incident, business constraints (e.g., deadlines or priorities), regulatory requirements, and/or the like.

For repeated security incidents, the computer system 210 may calculate an average resolution time based on historical occurrences of similar security incidents. By analyzing the number of times an incident has been previously addressed and the corresponding resolution times, the computer system 210 may refine predictions for future security incidents. This approach may utilize historical data to provide a more accurate estimate of resolution times, enabling organizations to allocate resources effectively and prioritize recurring threats.

As further shown in FIG. 2B, and by reference number 230, the computer system 210 may provide the estimated time for resolution of the old security incident for display. For example, the computer system 210 may output the estimated time for resolution of the old security incident to a user of the computer system 210, along with any relevant contextual information, such as confidence intervals for the prediction, factors contributing to the predicted resolution time, recommendations for mitigating the security incident, and/or the like. In some implementations, the computer system 210 may provide the estimated time for resolution of the old security incident to the security system 205, and the security system 205 may provide the estimated time for resolution for display to a user of the security system 205.

As shown in FIG. 2C, and by reference number 235, the computer system 210 may identify security rules that triggered the security incident based on determining that the security incident is a new security incident. For example, if the computer system 210 determines that the security incident is a new security incident, the computer system 210 may identify security rules that triggered the security incident in the security system 205. The computer system 210 may identify the security rules that triggered the security incident by retrieving incident data associated with the new security incident. The incident data may include, but is not limited to, network traffic logs, system logs (e.g., authentication logs and access control logs), intrusion detection system (IDS) alerts, anomaly detection system alerts, file integrity monitoring data, registry key modification data, and/or the like. The computer system 210 may parse the retrieved incident data to extract relevant information, such as source network addresses (e.g., Internet protocol (IP) addresses), destination network addresses (e.g., destination IP addresses), ports, protocols, packet content (e.g., headers and payloads), log entries (e.g., login attempts and access requests), alert data (e.g., IDS alerts and anomaly detection alerts).

The computer system 210 may correlate the parsed incident data with the security rules stored in a data structure (e.g., a database, a table, a list, and/or the like) associated with the computer system 210. The security rules may include, but are not limited to, firewall rules, intrusion prevention system (IPS) rules, access control lists (ACLs), authentication policies, authorization policies, encryption policies, malware detection rules, and/or the like. The computer system 210 may identify the security rules that match the incident data. For example, if the incident data indicates a suspicious network connection from a specific IP address, the computer system 210 may identify the firewall rule that allowed the connection to be established. The computer system 210 may analyze the identified security rules to determine configurations of the identified security rules, such as rule enablement status (e.g., enabled or disabled), rule priority, rule triggering conditions (e.g., packet contents and log entries), rule actions (e.g., allow, deny, or log), and/or the like.

The computer system 210 may evaluate how the identified security rules interact with each other and with other security measures, such as firewall rule conflicts, IPS rule conflicts, authentication policy conflicts, authorization policy conflicts, and/or the like. The computer system 210 may then determine which security rules contributed to the security incident. This may include identifying the security rules that allowed the security incident to occur, identifying the security rules that did not prevent the security incident, identifying the security rules that were bypassed or circumvented, and/or the like. In some implementations, the computer system 210 may report the contributing security rules to a user of the computer system 210, along with relevant information, such as security rule names, security rule descriptions, security rule configurations, security rule interactions, and/or the like.

In some implementations, the computer system 210 may utilize various techniques to identify the security rules that triggered the security incident. For example, the computer system 210 may utilize regex matching which uses regular expressions to match incident data against security rule patterns. The computer system 210 may utilize string matching models to compare incident data against security rule strings, and/or may utilize tree-based data structures to compare incident data against security rule trees. Additionally, or alternatively, the computer system 210 may utilize logical reasoning techniques to evaluate security rule interactions and determine contributing security rules, and/or may utilize machine learning models to analyze incident data and security rules to identify patterns and anomalies. By identifying the security rules that triggered the security incident, the computer system 210 may provide valuable insights to security administrators and analysts, helping them to understand the causes of the security incident and how to prevent similar incidents in the future, optimize security rules to prevent similar incidents and reduce false positives, improve incident response procedures by identifying the most effective security measures to mitigate the security incident, and/or the like.

As shown in FIG. 2D, and by reference number 240, the computer system 210 may map the security rules to security use cases. For example, the computer system 210 may retrieve a set of predefined security use cases from a database or a knowledge base associated with the computer system 210. The security use cases may include high-level descriptions of potential security threats or scenarios that an organization may face. The computer system 210 may analyze metadata associated with each security rule, such as rule name, rule description, rule type (e.g., a firewall rule or an IPS rule), a rule category (e.g., network security or endpoint security), and/or the like. The computer system 210 may identify the security use cases that are relevant to each security rule based on the rule metadata. For example, if a security rule is related to network security, the computer system 210 may identify security use cases related to network attacks, such as unauthorized access to sensitive data, malware propagation through the network, DoS attacks, and/or the like.

In some implementations, the computer system 210 may map each security rule to one or more security use cases based on the analysis of the rule metadata and the identified relevant security use cases. This mapping may be represented as a many-to-many relationship, where a single security rule may be related to multiple security use cases, and a single security use case may be related to multiple security rules. The computer system 210 may assign a confidence score to each mapping between a security rule and a security use case. The confidence score may represent a likelihood that the security rule is related to the security use case. In some implementations, the computer system 210 may display the mappings between the security rules and the security use cases as a graph or a table to help security administrators and analysts understand the relationships between the security rules and the security use cases.

The computer system 210 may utilize various techniques to map security rules to security use cases. For example, the computer system 210 may utilize natural language processing (NLP) techniques to analyze the text descriptions of security rules and security use cases to identify relationships between them. Alternatively, or additionally, the computer system 210 may utilize machine learning models to analyze the metadata of security rules and security use cases to identify patterns and relationships between them. Alternatively, or additionally, the computer system 210 may utilize knowledge graph embeddings to represent security rules and security use cases as vectors in a high-dimensional space and identify relationships between them. Alternatively, or additionally, the computer system 210 may utilize rule-based systems to define explicit rules for mapping security rules to security use cases. Alternatively, or additionally, the computer system 210 may utilize ontology-based reasoning to define a common ontology for security rules and security use cases and reason about their relationships.

As shown in FIG. 2E, and by reference number 245, the computer system 210 may map the security use cases to mitigation steps. For example, the computer system 210 may retrieve a knowledge base that stores information about security use cases, mitigation steps utilized for the security of use cases, and relationships between the security use cases and the mitigation steps. The knowledge base may include a database, a data structure, or a set of rules that define the relationships between security use cases and mitigation steps. A mitigation step is a specific action or control measure taken to reduce or eliminate the risk associated with a security incident. The mitigation steps may include implementing security controls (e.g., firewalls, intrusion detection systems, or access controls), conducting vulnerability assessments and penetration testing, developing and implementing incident response plans and procedures, providing security awareness training to employees, implementing patch management and software updates, conducting regular security audits and risk assessments, and/or the like.

The computer system 210 may analyze the security use cases to determine their corresponding mitigation steps. This analysis may include evaluating the characteristics of each security use case, such as the type of threat, the level of risk, and the potential impact on the IT infrastructure. Based on the analysis of the security use cases, the computer system 210 may identify the relevant mitigation steps that can be taken to address each security use case. The computer system 210 may create a mapping between the security use cases and the identified mitigation steps. The mapping may be represented as a table, a graph, or a set of rules that define the relationships between the security use cases and the mitigation steps.

In some implementations, the computer system 210 may assign confidence scores to each mapping to indicate the level of confidence in the effectiveness of the mitigation steps in addressing the corresponding security use case. These confidence scores may be based on various factors, such as the level of risk associated with the security use case, the effectiveness of the mitigation steps, and the level of expertise required to implement the mitigation steps. The computer system 210 may store the mapping between the security use cases and the mitigation steps in the knowledge base or a separate data structure. This mapping may be used to support future security incident response efforts.

The computer system 210 may utilize various techniques to map security use cases to mitigation steps. For example, the computer system 210 may utilize a rule-based system to define the relationships between security use cases and mitigation steps. The rule-based system may include a set of rules that are evaluated to determine the appropriate mitigation steps for a given security use case. Alternatively, or additionally, the computer system 210 may utilize computer system 210 may utilize machine learning models to predict the most effective mitigation steps for a given security use case. The machine learning models may be trained on historical data and may take into account various factors, such as the level of risk associated with the security use case and the effectiveness of the mitigation steps. Alternatively, or additionally, the computer system 210 may utilize ontology-based reasoning to define the relationships between security use cases and mitigation steps. This may include creating an ontology that represents the security use cases and mitigation steps as concepts and relationships, and using reasoning techniques to infer the most effective mitigation steps for a given security use case. Alternatively, or additionally, the computer system 210 may utilize NLP techniques to analyze the text descriptions of security use cases and mitigation steps to identify the most effective mitigation steps for a given security use case. This may include using NLP models to extract relevant information from the text descriptions and to identify patterns and relationships between the security use cases and mitigation steps.

As shown in FIG. 2F, and by reference number 250, the computer system 210 may map the mitigation steps to rule responses. For example, the computer system 210 may retrieve a knowledge base of pre-defined rule responses that are associated with specific mitigation steps. The knowledge base may be a database, a data structure, or a set of rules that define the relationships between mitigation steps and rule responses. The computer system 210 may analyze the mitigation steps to determine the corresponding rule responses. The analysis may include evaluating the characteristics of each mitigation step, such as the type of security control, the level of risk, and the potential impact on the IT infrastructure. Based on the analysis of the mitigation steps, the computer system 210 may identify the relevant rule responses that can be triggered to implement the mitigation steps. The rule responses may include, but are not limited to, blocking or allowing network traffic based on specific source or destination IP addresses, ports, or protocols, generating alerts or notifications to security teams or incident response teams, implementing access controls, such as granting or revoking user access to specific resources, conducting vulnerability scans or penetration testing, applying patches or software updates to specific systems or applications, and/or the like.

The computer system 210 may create a mapping between the mitigation steps and the identified rule responses. This mapping may be represented as a table, a graph, or a set of rules that define the relationships between the mitigation steps and the rule responses. In some implementations, the computer system 210 may assign confidence scores to each mapping to indicate the level of confidence in the effectiveness of the rule response in implementing the corresponding mitigation step. The confidence scores may be based on various factors, such as the level of risk associated with the mitigation step, the effectiveness of the rule response, and the level of expertise required to implement the rule response. The computer system 210 may store the mapping between the mitigation steps and the rule responses in the knowledge base or a separate data structure. The mapping may be used to support future security incident response efforts.

The computer system 210 may utilize various techniques to map the mitigation steps to the rule responses. For example, the computer system 210 may utilize a rule-based system to define the relationships between the mitigation steps and the rule responses. The system may include a set of rules that are evaluated to determine the appropriate rule responses for a given mitigation step. Alternatively, or additionally, the computer system 210 may utilize machine learning models to predict the most effective rule responses for a given mitigation step. The machine learning models may be trained on historical data and may consider various factors, such as the level of risk associated with the mitigation step and the effectiveness of the rule response. Alternatively, or additionally, the computer system 210 may utilize ontology-based reasoning to define the relationships between the mitigation steps and the rule responses. This may include creating an ontology that represents the mitigation steps and rule responses as concepts and relationships, and using reasoning techniques to infer the most effective rule responses for a given mitigation step. Alternatively, or additionally, the computer system 210 may utilize decision trees to map the mitigation steps to the rule responses.

As shown in FIG. 2G, and by reference number 255, the computer system 210 may calculate times for completing the rule responses and may add the times together to generate an estimated time for resolution of the new security incident. For example, the computer system 210 may calculate the times for completing the rule responses by retrieving a library of pre-defined times for completing specific rule responses. The library may be a database, a data structure, or a set of rules that define the estimated times for completing each rule response. The computer system 210 may analyze the identified rule responses to determine the corresponding times for completion. The analysis may include evaluating the characteristics of each rule response, such as the complexity of the task, the level of expertise required, and the potential impact on the IT infrastructure. Based on the analysis of the rule responses, the computer system 210 may estimate the time required to complete each rule response. The estimate may be based on various factors, such as historical data on completion times for similar rule responses, a level of expertise required to complete the rule response, a complexity of the task, a potential impact on the IT infrastructure, and/or the like.

The computer system 210 may calculate the estimated time for resolution of the new security incident by adding the estimated times for each rule response together. In some implementations, the computer system 210 may calculate the estimated time for resolution by using simple addition (e.g., by adding the estimated times for each rule response together), weighted addition (e.g., assigning weights to each of the estimated times based on priority, complexity, or impact, and then add the weighted times together), a critical path analysis (e.g., identifying a critical path of rule responses that need to be completed in a specific order, and then calculating the total time required to complete the critical path), and/or the like.

As further shown in FIG. 2G, and by reference number 260, the computer system 210 may provide the estimated time for resolution of the new security incident for display. For example, the computer system 210 may output the estimated time for resolution of the new security incident to a user of the computer system 210, along with any relevant contextual information, such as confidence intervals for the prediction, factors contributing to the predicted resolution time, recommendations for mitigating the security incident, and/or the like. In some implementations, the computer system 210 may provide the estimated time for resolution of the new security incident to the security system 205, and the security system 205 may provide the estimated time for resolution for display to a user of the security system 205.

As shown in FIG. 2H, and by reference number 265, the computer system 210 may map the mitigation steps to items in a workflow that is triggered and may identify features associated with the items. For example, the computer system 210 may map the mitigation steps to items in a workflow that is triggered and may identify features associated with the items by retrieving a pre-defined workflow template that outlines the steps required to resolve a security incident. The workflow template may be a database, a data structure, or a set of rules that define the sequence of tasks to be performed. The computer system 210 may analyze the mitigation steps to determine the corresponding items in the workflow. This analysis may include evaluating the characteristics of each mitigation step, such as the type of security control, the level of risk, and the potential impact on the IT infrastructure. Based on the analysis of the mitigation steps, the computer system 210 may map each mitigation step to a corresponding item in the workflow. The mapping may be performed using various techniques, such as keyword matching (e.g., matching keywords in the mitigation steps to keywords in the workflow items), regular expression matching (e.g., utilizing regular expressions to match patterns in the mitigation steps to patterns in the workflow items), machine learning models (e.g., to predict the mapping between mitigation steps and workflow items based on historical data), and/or the like.

Once the mitigation steps have been mapped to the workflow items, the computer system 210 may identify the features associated with each item. These features may include, but are not limited to, a type of task or activity required to complete the item (e.g., a network block, an alert generation, or a patch application), resources required to complete the item (e.g., personnel, equipment, or software), dependencies between items (e.g., an item that requires completion of a previous item), a priority of an item (e.g., high, medium, or low), an estimated time required to complete the item, and/or the like. In some implementations, each of the features may an estimated time to complete a workflow item. The computer system 210 may use various techniques to identify the features associated with each item, including machine learning models to predict the features associated with each item based on historical data and various input variables, regression analysis to model the relationship between input variables and the features associated with each item, simulation modeling to simulate the completion of each item and estimate the features associated with each item, and/or the like. In some implementations, the computer system 210 may store the mapped workflow and the features in a database, a data structure, or a set of rules that define the relationships between the mitigation steps, the workflow items, and the features.

As shown in FIG. 2I, and by reference number 270, the computer system 210 may calculate times for completing the items based on the features and may add the times together to generate an estimated time for resolution of the new security incident. For example, the computer system 210 may calculate the times for completing the items based on the features by utilizing a time estimation model that takes into account the features associated with each item in the workflow. This model may be a machine learning model, a regression analysis model, or a simulation model. The computer system 210 may analyze the features associated with each workflow item to determine the input variables for the time estimation model. These input variables may include, but are not limited to, item type, resource requirements, dependencies, priority, estimated time for completion, and/or the like. The computer system 210 may use the time estimation model to calculate the time required to complete each item in the workflow. This calculation may be based on the input variables determined by the computer system 210. The computer system 210 may add the calculated times for completing each item together to generate an estimated time for resolution of the new security incident. The estimated time for resolution may take into account the dependencies between items and the priority of each item. In some implementations, the computer system 210 may calculate the estimated time for resolution by using simple addition, weighted addition, a critical path analysis, and/or the like.

As further shown in FIG. 2I, and by reference number 275, the computer system 210 may provide the estimated time for resolution of the new security incident for display. For example, the computer system 210 may output the estimated time for resolution of the new security incident to a user of the computer system 210, along with any relevant contextual information, such as confidence intervals for the prediction, factors contributing to the predicted resolution time, recommendations for mitigating the security incident, and/or the like. In some implementations, the computer system 210 may provide the estimated time for resolution of the new security incident to the security system 205, and the security system 205 may provide the estimated time for resolution for display to a user of the security system 205.

In some implementations, the computer system 210 may continuously monitor the in-flight movement of security incidents as the security incident progress through various stages of resolution. By tracking the status of a security incident in real-time, the computer system 210 may provide updates on a current phase of resolution, a time elapsed in each phase, and any changes in estimated resolution time. This ongoing assessment may enable stakeholders to understand where a security incident stands in the resolution process, enabling them to make informed decisions about resource allocation and urgency. This feature ensures transparency and accountability in incident management, providing executives and analysts with a clear view of the resolution timeline and any potential delays.

In some implementations, the computer system 210 may identify potential blocking points or failure points that may hinder the resolution of a security incident. These points may include necessary approvals for specific actions, unavailability of key personnel, or dependencies on third-party services. By recognizing these obstacles, the computer system 210 may alert analysts and decision-makers to potential delays and may suggest alternative pathways to mitigate these issues. This proactive identification of impediments may ensure that the resolution process can proceed smoothly, minimizing downtime and optimizing resource use.

In some implementations, the computer system 210 may include a prioritization mechanism that prioritizes security incidents based on the predicted time to resolution and/or other factors. By prioritizing different security incidents, the computer system 210 may enable analysts to prioritize their workflow, focusing on incidents that are more critical or those that can be resolved more quickly. This prioritization may help to optimize resource allocation, ensuring that security incidents with higher severity or impact are addressed promptly, while less critical security incidents are queued accordingly. This may enhance the efficiency of a security incident response team and may align resolution efforts with organizational priorities and strategic goals.

In this way, the computer system (e.g., the computer system 210) predicts time to resolution of security incident. For example, the computer system may optimize resource allocation and reduce computational overhead by predicting the time to resolution of a security incident. The computer system may streamline the resolution process by reducing the need for manual intervention, minimizing the number of redundant tasks, and optimizing the execution of rule responses. The computer system may also reduce network latency and improve system availability by quickly resolving security incidents and minimizing downtime. Thus, the computer system conserves computing resources, networking resources, and/or the like that would otherwise have been consumed by failing to predict resolution times for security incidents, failing to prioritize security incidents based on failing to predict the resolution times, allocating insufficient resources to security incidents based on failing to predict the resolution times, handling downtime based on failing to predict the resolution times, and/or the like.

As indicated above, FIGS. 2A-2I are provided as an example. Other examples may differ from what is described with regard to FIGS. 2A-2I. The number and arrangement of devices shown in FIGS. 2A-2I are provided as an example. In practice, there may be additional devices, fewer devices, different devices, or differently arranged devices than those shown in FIGS. 2A-2I. Furthermore, two or more devices shown in FIGS. 2A-2I may be implemented within a single device, or a single device shown in FIGS. 2A-2I may be implemented as multiple, distributed devices. Additionally, or alternatively, a set of devices (e.g., one or more devices) shown in FIGS. 2A-2I may perform one or more functions described as being performed by another set of devices shown in FIGS. 2A-2I.

FIG. 3 is a flowchart of an example process 300 associated with predicting time to resolution of security incident. One or more process blocks of FIG. 3 are performed by a computer system (e.g., computer 102, the security system 205, and/or the computer system 210) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or security code 150.

As shown in FIG. 3, process 300 may include receiving a security incident from a security system (block 310). For example, the computer system may receive a security incident from a security system, as described above.

As further shown in FIG. 3, process 300 may include determining whether the security incident is an old security incident or a new security incident (block 320). For example, the computer system may determine whether the security incident is an old security incident or a new security incident, as described above.

As further shown in FIG. 3, process 300 may include selectively processing the security incident, with a machine learning model and based on determining that the security incident is an old security incident, to predict an estimated time for resolution of the old security incident, or performing one or more actions based on determining that the security incident is a new security incident and to predict an estimated time for resolution of the new security incident (block 330). For example, the computer system may selectively process the security incident, with a machine learning model and based on determining that the security incident is an old security incident, to predict an estimated time for resolution of the old security incident, or perform one or more actions based on determining that the security incident is a new security incident and to predict an estimated time for resolution of the new security incident, as described above.

In some implementations, processing the security incident, with the machine learning model, to predict the estimated time for resolution of the old security incident includes analyzing historical data related to the security incident to predict the estimated time for resolution of the old security incident based on a type associated with the security incident, a complexity of the security incident, and an availability of resources. In some implementations, the type associated with the security incident is determined based on a categorization of a security rule triggered by the security incident, the complexity of the security incident is determined based on a number of hosts affected by the security incident, and the availability of resources is determined based on an availability of personnel and technology required to resolve the security incident.

In some implementations, performing the one or more actions includes identifying security rules that triggered the security incident based on determining that the security incident is a new security incident, mapping the security rules to security use cases, and mapping the security use cases to mitigation steps. In some implementations, performing the one or more actions includes mapping the mitigation steps to rule responses, calculating times for completing the rule responses, and adding the times together to generate the estimated time for resolution of the new security incident.

In some implementations, performing the one or more actions includes mapping the mitigation steps to items in a workflow, identifying features associated with the items, calculating times for completing the items based on the features, and adding the times together to generate an estimated time for resolution of the new security incident. In some implementations, the features include one or more of whether the items can be executed in parallel, whether the items require approval, availability of approval authority for the items, or whether the items are associated with another workflow.

In some implementations, process 300 includes providing for display one of the estimated time for resolution of the old security incident or the estimated time for resolution of the new security incident. In some implementations, process 300 includes providing, to the security system, one of the estimated time for resolution of the old security incident or the estimated time for resolution of the new security incident.

In some implementations, process 300 includes training the machine learning model with a dataset of historical security incidents and corresponding resolution times for the historical security incidents. In some implementations, process 300 includes identifying blocking points or failure points associated with resolution of the security incident. In some implementations, process 300 includes providing recommendations for mitigating the blocking points or failure points. In some implementations, process 300 includes prioritizing the security incident based on one of the estimated time for resolution of the old security incident or the estimated time for resolution of the new security incident.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a security incident from a security system;
determining whether the security incident is an old security incident or a new security incident; and
selectively:
processing the security incident, with a machine learning model and based on determining that the security incident is an old security incident, to predict an estimated time for resolution of the old security incident, or
performing one or more actions based on determining that the security incident is a new security incident and to predict an estimated time for resolution of the new security incident.

2. The method of claim 1, further comprising:
providing for display one of the estimated time for resolution of the old security incident or the estimated time for resolution of the new security incident.

3. The method of claim 1, further comprising:
providing, to the security system, one of the estimated time for resolution of the old security incident or the estimated time for resolution of the new security incident.

4. The method of claim 1, wherein performing the one or more actions comprises:
identifying security rules that triggered the security incident based on determining that the security incident is a new security incident;
mapping the security rules to security use cases; and
mapping the security use cases to mitigation steps.

5. The method of claim 4, wherein performing the one or more actions comprises:
mapping the mitigation steps to rule responses;
calculating times for completing the rule responses; and
adding the times together to generate the estimated time for resolution of the new security incident.

6. The method of claim 4, wherein performing the one or more actions comprises:
mapping the mitigation steps to items in a workflow;
identifying features associated with the items;
calculating times for completing the items based on the features; and
adding the times together to generate an estimated time for resolution of the new security incident.

7. The method of claim 6, wherein the features include one or more of whether the items can be executed in parallel, whether the items require approval, availability of approval authority for the items, or whether the items are associated with another workflow.

8. A computer system, comprising:
a processor set;
one or more computer-readable storage media; and
program instructions stored on the one or more computer-readable storage media to cause the processor set to perform operations comprising:
receiving a security incident from a security system;
determining whether the security incident is an old security incident or a new security incident;
selectively:
processing the security incident, with a machine learning model and based on determining that the security incident is an old security incident, to predict an estimated time for resolution of the old security incident, or
performing one or more actions based on determining that the security incident is a new security incident and to predict an estimated time for resolution of the new security incident; and
outputting one of the estimated time for resolution of the old security incident or the estimated time for resolution of the new security incident.

9. The computer system of claim 8, wherein processing the security incident, with the machine learning model, to predict the estimated time for resolution of the old security incident comprises:
analyzing, by the machine learning model, historical data related to the security incident to predict the estimated time for resolution of the old security incident based on a type associated with the security incident, a complexity of the security incident, and an availability of resources.

10. The computer system of claim 9, wherein the type associated with the security incident is determined based on a categorization of a security rule triggered by the security incident, the complexity of the security incident is determined based on a number of hosts affected by the security incident, and the availability of resources is determined based on an availability of personnel and technology required to resolve the security incident.

11. The computer system of claim 8, wherein the operations further comprise:
training the machine learning model with a dataset of historical security incidents and corresponding resolution times for the historical security incidents.

12. The computer system of claim 8, wherein the operations further comprise:
identifying blocking points or failure points associated with resolution of the security incident.

13. The computer system of claim 12, wherein the operations further comprise:
providing recommendations for mitigating the blocking points or failure points.

14. The computer system of claim 8, wherein the operations further comprise:
prioritizing the security incident based on one of the estimated time for resolution of the old security incident or the estimated time for resolution of the new security incident.

15. A computer program product, comprising:
one or more computer-readable storage media; and
program instructions stored on the one or more computer-readable storage media to perform operations, the operations comprising:
receiving a security incident from a security system;
determining whether the security incident is an old security incident or a new security incident;
selectively:
processing the security incident, with a machine learning model and based on determining that the security incident is an old security incident, to predict an estimated time for resolution of the old security incident, or
performing one or more actions based on determining that the security incident is a new security incident and to predict an estimated time for resolution of the new security incident; and
providing for display one of the estimated time for resolution of the old security incident or the estimated time for resolution of the new security incident.

16. The computer program product of claim 15, wherein the operations further comprise:
providing, to the security system, one of the estimated time for resolution of the old security incident or the estimated time for resolution of the new security incident.

17. The computer program product of claim 15, wherein performing the one or more actions comprises:
identifying security rules that triggered the security incident based on determining that the security incident is a new security incident;
mapping the security rules to security use cases; and
mapping the security use cases to mitigation steps.

18. The computer program product of claim 17, wherein performing the one or more actions comprises:
mapping the mitigation steps to rule responses;
calculating times for completing the rule responses; and
adding the times together to generate the estimated time for resolution of the new security incident.

19. The computer program product of claim 17, wherein performing the one or more actions comprises:
mapping the mitigation steps to items in a workflow;
identifying features associated with the items;
calculating times for completing the items based on the features; and
adding the times together to generate an estimated time for resolution of the new security incident.

20. The computer program product of claim 15, wherein processing the security incident, with the machine learning model, to predict the estimated time for resolution of the old security incident comprises:
analyzing, by the machine learning model, historical data related to the security incident to predict the estimated time for resolution of the old security incident based on a type associated with the security incident, a complexity of the security incident, and an availability of resources.
